(19) United States
(12) Patent Application Publication
(10) Pub. No.: US 2002/0102154 A1
(43) Pub. Date: Aug. 1, 2002

(54) MECHANICAL LINKAGE QUICK ATTACHMENT SYSTEM

(76) Inventors: THOMAS P. MULLER, MONTGOMERY, IL (US); JEAN PAUL EMOND, PLANCENOIT (BE)

Correspondence Address: BYRON G BUCK II, CATERPILLAR INC, PATENT DEPARTMENT AB6490, 100 N E ADAMS STREET, PEORIA, IL, 616296490

(21) Appl. No.: 09/406,022

(22) Filed: Sep. 24, 1999

(51) Int. Cl. B66F 9/00

(52) U.S. Cl. 414/723

(57) ABSTRACT

An attachment system for coupling a plurality of work tools to a single articulated work machine including a base module fixed to the articulated front portion of the work machine and a plurality of adapter members, each adapter member being cooperatively engageable with the base module and each being adaptable for engaging at least one of the plurality of work tools, all of the plurality of work tools being operatively coupled to the single work machine when the base module is cooperatively engaged with the appropriate adapter member for a particular work tool. One of the adapter members is specifically constructed for engaging a work tool having a Z-bar type linkage construction associated therewith including appropriate power providers for controlling the operation of that particular attachment tool, and one of the adapter members is specifically constructed for engaging a work tool having an integrated tool carrier type linkage construction associated therewith including appropriate power providers for controlling the operation of that particular attachment tool. Other adapter members may include a rotating table type member as well as appropriate arm members for engaging a dozer blade, other blade type work tools, and a wide variety of other types of multi-purpose work tools.

### TECHNICAL FIELD

This invention relates generally to the field of work tool attachments and, more particularly, to a quick attachment system which includes a base module and a plurality of adapters for connecting a wide variety of different types of work tools including any associated linkage to a single work machine.

### BACKGROUND ART

Work machines such as wheel and track type loaders, tractors, and other earth working machines are widely used for a variety of different purposes. Such machines are normally provided a lift apparatus or some type of hitch member for securing a working tool or implement to the work machine for operation thereof. Many different types of attachment tools or implements may be provided for use with a specific type of work machine such as a bucket, a dozer or other fixed-blade applications, a trencher, a scarifier, a crane boom, a telescopic boom trencher, a drill, a tree planter, a post hole digger, a snow blower, a wide variety of different brush and vacuum cleaner applications, a bush/brushes cutter, a sprayer, a mast, a log stacker, and a wide variety of towing/pushing applications. Each of these tools or attachments are usually separate or independent pieces of equipment thus requiring removal of one apparatus and installation of another apparatus for performing the desired plurality of work applications and/or operations. In addition, each of these different types of tools and/or attachments are usually designed for use with a particular type of work machine such as a wheel loader, an excavator, a tractor and the like. Also, many of these tools and/or attachments are likewise specifically designed for use with one particular brand of work machine. As a result, depending upon the type and/or brand of work machine involved, it is often times necessary to replace all or at least some of the tools and/or implement attachments to be utilized in conjunction with a particular work machine.

Of the known systems and mechanisms for attaching a work implement or attachment tool to the front of a particular vehicle or work machine, such systems and mechanisms are typically time consuming and, for the most part, cannot be effectively accomplished in the field. Such known systems typically include some type of changeable hitch arrangement or other interfacing quick release device for engaging a particular attachment or implement, or such known systems include some type of bracket or other mounting arrangement which must be fixedly secured to both the work machine and to the particular attachment or tool involved in order to accomplish the tool/work machine attachment. Still further, often times, each particular type of working attachment or tool requires its own mounting or bracket assembly which is specifically adapted to be connected to a particular work machine involved. These bracket assemblies typically must be modified each time they are connected to a different type of work machine.

The hook type quick coupling construction disclosed in U.S. Pat. No. 4,717,166 is typical of the known coupling systems for attaching a work implement to the front of a vehicle such as a tractor wherein a front push-frame is adapted to be attached to the front portion of a tractor chassis and a hook frame member is adapted to be attached to the back of a particular work implement such as a plow or snow blower. To couple the hook frame member to the front push-frame, the hook members associated with the hook frame member must be dropped unto the studs associated with the front push-frame and a spring biased locking pin must be positioned within holes associated with the hook frame member. This type of coupling arrangement is not adaptable for use with a wide variety of different work attachments or tools such as traditional Z-bar linkage type applications, traditional integrated tool (IT) carrier type applications and other applications.

It is therefore desirable to provide a quick attachment system which would allow a plurality of different types of work tool attachments to be quickly mounted to the same work machine, and wherein such tool/machine attachment can be accomplished in the field. It is also desirable to provide a quick attachment system which will greatly increase the versatility of a single work machine as compared to the versatility currently available through use of the known quick change attachment systems. It is still further desirable to provide an attachment system which will be compatible with and accommodate a wide variety of different types of linkage arrangements associated with different types of tool attachments.

Accordingly, the present invention is directed to overcoming one or more of the problems as set forth above.

### DISCLOSURE OF THE INVENTION

In accordance with the teachings of the present invention, a quick coupling system for attaching a work attachment tool to the front of a particular articulated work machine is disclosed. The present system comprises a standardized base module which is integrally formed or otherwise associated with the front frame of a particular work machine and a plurality of adapter members constructed for engaging both the base module as well as any one or more of a plurality of different attachment tools. The front frame base module is positioned and located for easy access at the front of the work machine and includes cooperatively engageable means for selectively engaging any one of the plurality of different adapter members as will be hereinafter further explained.

Each of the plurality of differently shaped adapter members are constructed for cooperatively engaging the standardized base module associated with a particular work machine and each adapter member includes means for attaching to a specific attachment tool including any linkage assembly associated therewith, some of the adapter members being attachable to a plurality of different types of attachment tools. The present adapters provide an attachment point for traditional Z-bar applications, traditional IT/parallel lift applications, a dozer blade and/or fixed-blade applications, rotating table applications such as drill applications, and a wide variety of multi-purpose front end applications such as a snow blower, rotating brush, sprayer and other such general use applications. As a result, the same articulated work machine could be utilized as a wheel loader, a wheel dozer, a tractor, or some other multi-purpose machine by simply selecting the appropriate adapter member for use with the desired work attachment tool to be utilized. Appropriate power providers usually in the form of hydraulic cylinders and/or actuators associated with a particular work attachment tool are coupled to the hydraulic systems associated with the particular work machine and control signals for operating and directing hydraulic fluid flow to the work attachment tool will be provided through systems associated with the work machine such as one or more electronic controllers or other control means.

The quick changing of a wide variety of different types of work attachment tools can also be accomplished in the field through the use of a plurality of mounting/storage stands adapted to hold the various attachment tools and adapters. When not in use, each attachment tool and/or corresponding adapter, can be stored on a corresponding stand which will position and orient the tool and/or adapter for easy attachment to the base module. When so positioned on an appropriate support means, the work machine can be driven and maneuvered to the appropriate support stand and positioned such that the appropriate adapter, or the appropriate adapter/tool combination, can be easily attached to the standardized base module associated with the machine while the adapter or adapter/tool combination is still resting on the support stand. Once attachment is complete, the work tool can be maneuvered such that the work machine can back away from the support stand taking the now-attached work tool with it. Other quick changing mechanisms and configurations are likewise possible and envisioned. The base module can therefore support a plurality of different adapters, each adapter being capable of supporting any number of different work attachment tools.

The present system therefore allows an operator to change machine characteristics and functions in the field, and it greatly increases the versatility of a single work machine as compared to other known attachment systems currently in use.

### BRIEF DESCRIPTION OF THE DRAWINGS

For a better understanding of the present invention, reference may be made to the accompanying drawings in which:

FIG. 1 is a perspective view of one embodiment of a base module constructed in accordance with the teachings of the present invention;

FIG. 2 is a perspective view of one embodiment of an adapter member constructed in accordance with the teachings of the present invention for coupling to a traditional Z-bar linkage type tool;

FIG. 3 is a side elevational view showing a typical Z-bar type linkage tool operatively attached to the adapter member of FIG. 2 and the base module of FIG. 1;

FIG. 4 is a side elevational view illustrating a typical support stand for holding and supporting a typical Z-bar type linkage tool and its associated adapter member;

FIG. 5 is a perspective view of another embodiment of an adapter member constructed in accordance with the teachings of the present invention for coupling to a traditional integrated tool carrier type tool;

FIG. 6 is a side elevational view showing a typical integrated tool carrier type tool operatively attached to the adapter member of FIG. 5 and the base module of FIG. 1;

FIG. 7 is side elevational view of another adapter member constructed in accordance with the teachings of the present invention;

FIG. 8 is a side elevational view illustrating the attachment of the adapter member of FIG. 7 to the base module of FIG. 1;

FIG. 9 is a side elevational view of another adapter member constructed in accordance with the teachings of the present invention;

FIG. 10 is a side elevational view illustrating the attachment of the adapter member of FIG. 9 to the base module of FIG. 1;

FIG. 11 is a side elevational view of still another adapter member constructed in accordance with the teachings of the present invention; and;

FIG. 12 is a side elevational view illustrating the attachment of the adapter member of FIG. 11 to the base module of FIG. 1.

### BEST MODE FOR CARRYING OUT THE INVENTION

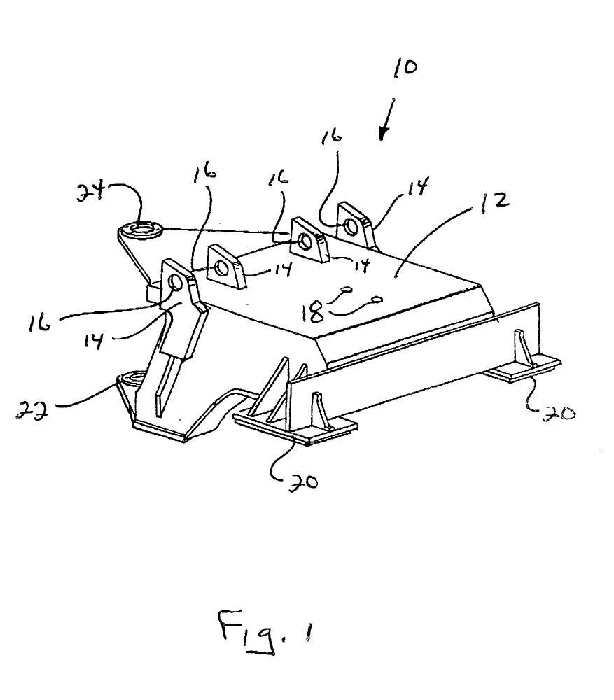

Referring to FIG. 1, number 10 in FIG. 1 represents one embodiment of the present front frame base module constructed in accordance with the teachings of the present invention, the base module 10 being either integrally formed with or attached to the front frame associated with a particular work machine such as an articulated wheel loader. The base module 10 includes a substantially planar upper surface 12 having a pair of flanges or ears 14 associated with each opposite side thereof, the respective pair of flanges 14 having respective openings 16 associated therewith for receiving a pin member therethrough. The flanges 14 are positioned and located for mating with and attaching to any one of a plurality of adapter members as will be hereinafter further explained. The upper surface 12 of base module 10 likewise includes a pair of openings 18 for receiving appropriate threaded members for further attaching the respective adapter members thereto. As shown in FIG. 1, the base module 10 also includes a pair of mounting plates or brackets 20 for attaching the front axial of the work machine thereto and the module 10 also includes pivot joints 22 and 24 which attach to the main frame of the work machine, the pivot joints 22 and 24 allowing the front portion of the work machine to articulate thereabout. Although FIG. 1 illustrates one embodiment of the present base module 10 and discloses a specific shape and flange arrangement, it is recognized and anticipated that other shapes and configurations as well as other flange configurations for mating and engaging with any one of a plurality of different adapter members will likewise work equally as well.

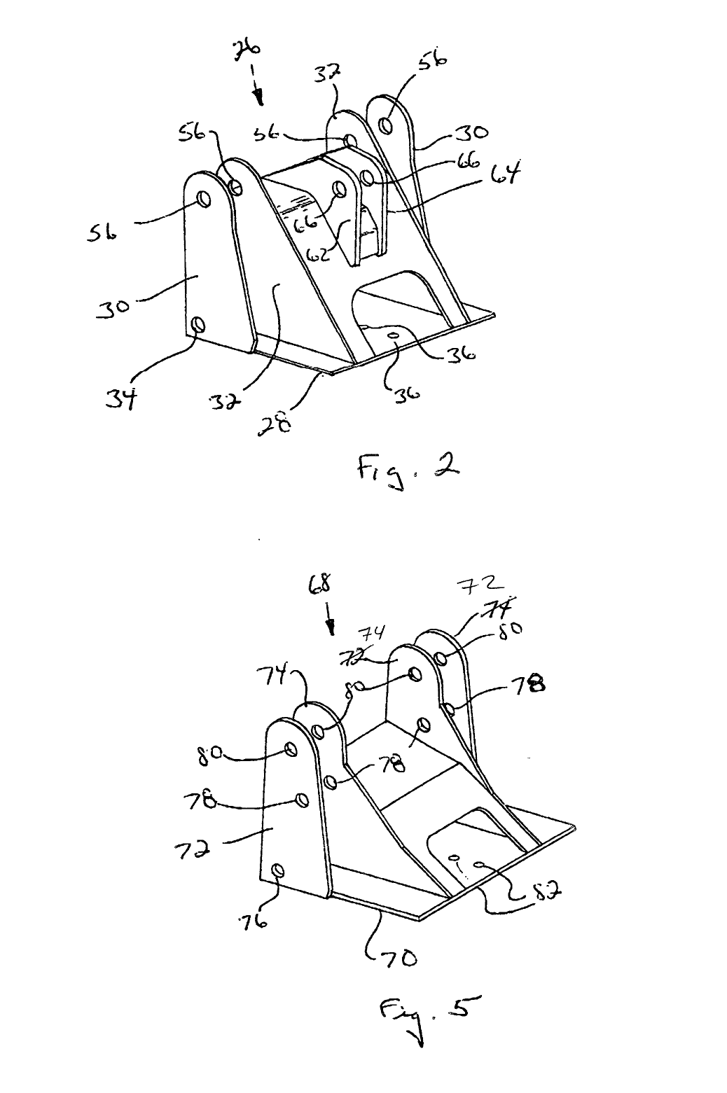

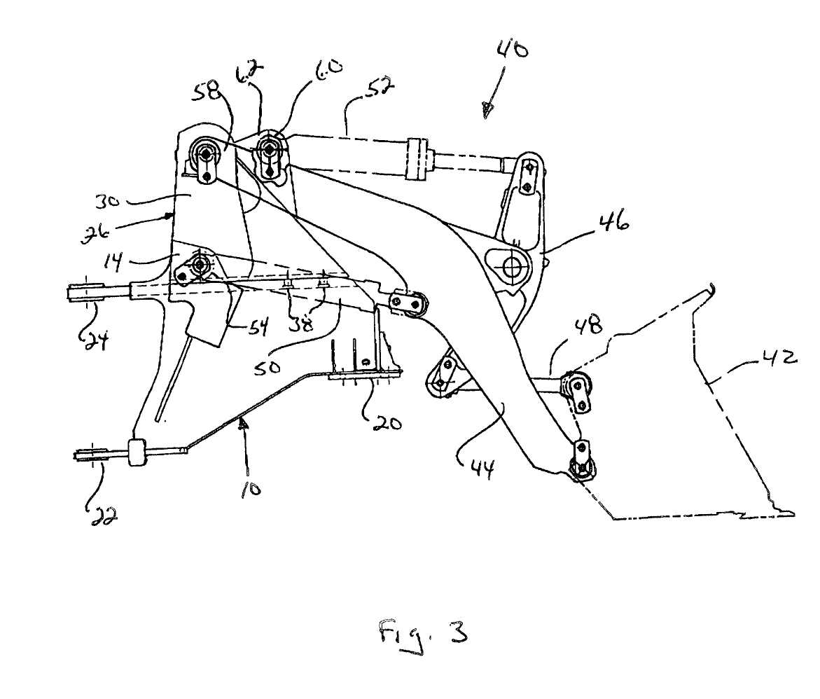

FIG. 2 illustrates one embodiment of an upper front frame adapter member 26 which is specifically constructed for use with traditional Z-bar linkage applications. The adapter member 26 includes a substantially planar bottom or base plate member 28 having a pair of upright flange members 30 and 32 associated with each opposite side thereof, the flange members 30 and 32 being positioned and arranged so as to cooperatively engage and mate with the flanges or ears 14 associated with base module 10. The respective pair of flange members 30 and 32 are positioned and located so as to slidably engage and fit inside of the respective pairs of flanges 14 associated with base module 10, the flange members 30 and 32 likewise including respective openings 34 for receiving a pin member therethrough. The openings 34 are positioned and located so as to register with the respective openings 16 associated with the base module flanges 14 when the adapter member 26 is properly positioned on base module 10. The base plate member 28 likewise includes a pair of openings 36 which are positioned and located so as to register with the openings 18 associated with base module 10 when adapter member 26 is properly positioned thereon. The openings 18 and 36 are adapted to receive corresponding fastening members such as the bolts 38 attached to the bottom portion of adapter 26 illustrated in FIG. 3. In this regard, it is recognized that any suitable type of fastening member can be used to further secure adapter member 26 to the upper surface 12 of base module 10.

As best shown in FIG. 3, adapter member 26 is specifically designed and constructed for attaching to a traditional Z-bar application such as an excavation bucket utilizing a Z-bar type linkage arrangement. More particularly, the attachment bucket tool 40 includes a bucket 42 and a Z-bar type linkage arrangement which includes a pair of lift arms 44, linkage members 46 and 48, a pair of hydraulic cylinders 50, and a hydraulic cylinder 52. Hydraulic cylinders 50 control the pivotable movement of lift arms 44 whereas hydraulic cylinder 52 controls the pivotable movement of bucket 42. The adapter member 26 is specifically designed to receive and engage the free end portions of lift arms 44 and hydraulic cylinders 50 and 52 as will now be explained.

As best shown in FIG. 3, the end portion 54 of each respective hydraulic cylinder 50 is positioned between the respective flange members 30 and 32 associated with adapter member 26 and the flange members 30 and 32 are likewise positioned between the respective flanges 14 associated with base module 10. This entire assembly is held in proper position on base module 10 through the use of pin members or other appropriate fastening and pivot means which are inserted through the respective openings 18 and 34 and through a corresponding opening associated with end portion 54 of each cylinder 50. In similar fashion, the respective lift arm members 44 are each attached to adapter 26 through the use of corresponding openings 56 associated with the upper portion of each of the flange members 30 and 32. In this regard, the end portion 58 of each respective lift arm 44 is positioned between the respective flange members 30 and 32 such that an opening through end portion 58 is located in registration with the respective openings 56. Attachment is accomplished through the use of a suitable pin member or other attachment means.

The adapter member 26 also includes a centrally located pair of flange members 62 and 64 which are positioned and located for cooperatively engaging end portion 60 of cylinder 52. In this regard, the flange members 62 and 64 likewise include corresponding openings 66 which are positioned and located for registering with a corresponding opening through cylinder end portion 60, a suitable pin member or other attachment means again completing the attachment of cylinder 52 to flange members 62 and 64. Once attachment bucket 40 is attached to adapter member 26 and base module 10 as indicated above, and the appropriate hydraulic connections associated with the work machine are connected to cylinders 50 and 52, the bucket tool 40 can be controlled and maneuvered in a conventional manner.

From the foregoing, it is apparent that the base module 10 is permanently mounted to or integrally formed as part of the front frame of a particular work machine. Adapter member 26, on the other hand, can either be permanently secured to a particular work tool attachment such as the bucket tool 40 including its associated Z-bar type linkage arrangement, or the adapter member 26 can remain separate from the bucket and Z-bar type linkage 40 until use is necessary. In either event, once an operator determines that the bucket tool 40 will be used for a particular work application, adapter member 26 is attached to the base module 40 as previously explained and, if the adapter member is not already secured to the bucket tool 40, the linkage and cylinders associated with tool 40 will be thereafter attached to adapter member 26 as likewise previously explained. The present adapter is therefore unique in that it will allow a working tool such as the bucket 42 to be removed from a particular work machine along with its associated articulation linkage and power providers (hydraulic cylinders) so that the complete tool attachment including linkage and power providers can be used on other work machines, and so that the same work machine can be used with other completely different tools having completely different linkage arrangements.

In order to speed up the attachment process and to more easily perform an attachment tool change in the field, it is envisioned that a work tool such as the tool 40 will be properly supported by some type of support structure or stand such as the support structure 67 illustrated in FIG. 4. Mounting/storage stands and other support structures are well known in the art and any suitable stand structure for elevating the attachment points of a particular tool may be utilized. FIG. 4 illustrates a typical storage stand 67 for holding the bucket tool 40 and its corresponding adapter member 26 already pre-attached thereto. In this situation, the stand 67 should be configured and dimensioned such that the work machine can be easily driven and maneuvered so as to substantially align the base plate member 28 of adapter 26 with the upper surface 12 associated with the base module 10. It is also recognized and anticipated that a separate mounting/storage stand can be utilized for holding both the adapter member 26 and its associated tool 40 when not in use, the adapter storage stand being configured and dimensioned so as to enable an operator to maneuver the base module 10 associated with a particular work machine under the adapter member for quick and easy attachment thereto, whereas the tool storage stand would be configured and dimensioned to enable an operator to maneuver the mounting points associated with the appropriate adapter into substantial alignment with the connection points associated with the particular tool.

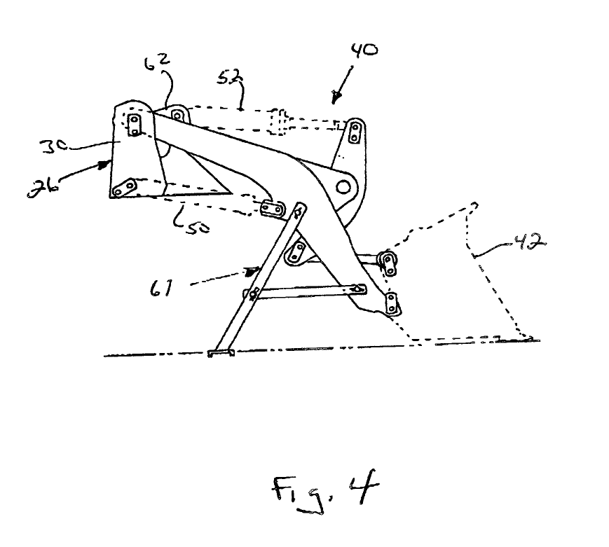

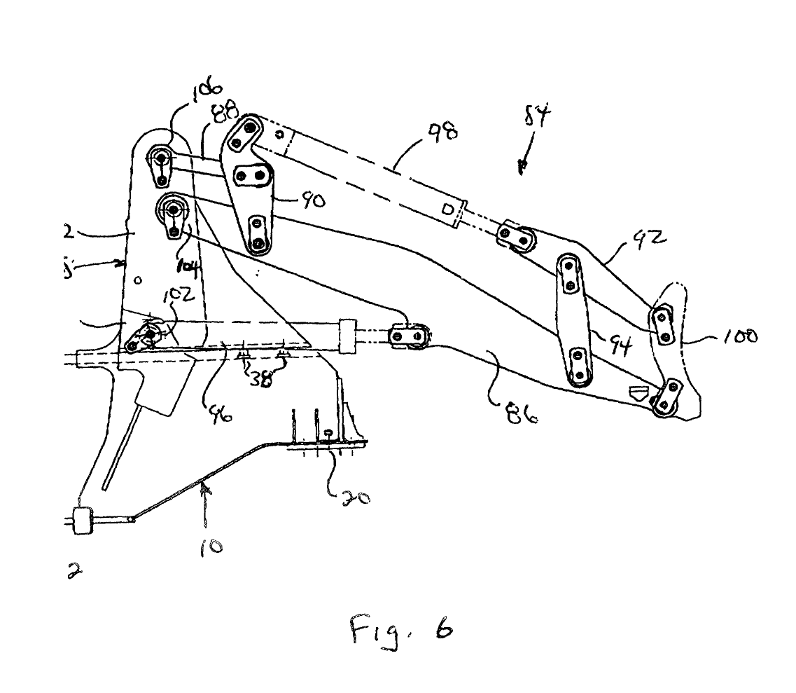

FIGS. 5 and 6 illustrate another embodiment of an adapter member 68 which is specifically designed and configured for use with traditional IT (Integrated Tool) or parallel lift type applications. A typical IT type linkage arrangement associated with a bucket or other attachment tool is illustrated in FIG. 6. The adapter member 68 is somewhat similar to adapter member 26 but is specifically configured for mating with the attachment points associated with an IT type tool. For example, like adapter member 26, adapter member 68 includes a substantially planar base plate member 70 having a pair of flange members 72 and 74 associated with each opposite side thereof, the flange portions 72 and 74 each including a plurality of openings 76, 78 and 80 for mating with the free end portions of an IT type linkage tool as will be hereinafter further explained. The base plate member 70 likewise includes a pair of openings 82 for mating with the openings 18 associated with base module 10, the base plate member 70 being further secured to the upper surface 12 of base module 10 through the use of suitable fastening members such as the bolts 38 illustrated in FIG. 6. Like the flange members 30 and 32 and their corresponding openings 34, the flange members 72 and 74 and their corresponding openings 76 are positioned and located so as to mate with and fit inside of the flanges 14 associated with base module 10, the respective openings 16 and 76 lying in registration with each other and being adaptable for receiving a pin member or other fastening and pivot means similar to the attachment of adapter member 26 to base module 10.

FIG. 6 illustrates how a typical IT carrier type tool is mounted to adapter member 68 which in turn is mounted to base module 10. More particularly, IT attachment tool 84 includes a pair of lift arms 86, a plurality of linkage members such as the members 88, 90, 92 and 94, a pair of hydraulic cylinders 96 and a pair of hydraulic cylinders 98. The hydraulic cylinders 96 are positioned and located for controlling movement of the respective lift arms 86 whereas the hydraulic cylinders 98 are positioned and located for controlling movement of a typical tool 100 attached to the integrated tool carrier 84 such as a bucket or other tool. Similar to the hydraulic cylinders 50 associated with attachment tool 40, the end portion 102 of each hydraulic cylinder 96 is attached to a respective pair of flange members 72 and 74 associated with adapter member 68 and to a respective pair of flanges 14 associated with base module 10 in a similar fashion as previously explained with respect to the bucket tool 40. In this regard, the hole associated with cylinder end portion 102 is positioned in registration with the respective openings 16 and 76 and the cylinders 96 are held in their respective pivotable positions through the use of a pin member or other pivotable attachment means.

In similar fashion, the end portion 104 associated with each lift arm member 86 and the end portion 106 associated with each linkage member 88 are positioned in registration with respective openings 78 and 80 associated with flange members 72 and 74 such that the members 86 and 88 are pivotally attached thereto through appropriate pivot means. In this regard, the linkage end portions 104 and 106 will each include an opening therethrough for registering with the respective openings 78 and 80 and for receiving the appropriate pivot means. Once the appropriate hydraulic connections associated with the work machine are attached to the hydraulic cylinders 96 and 98, the attachment tool 84 can be controlled and manipulated in a typical manner. Use of adapter member 68 therefore enables any IT type tool to be attached to the base module 10 for use with the same work machine which is likewise capable of utilizing the Z-bar type bucket tool 40 illustrated in FIG. 3. Like bucket tool 40, it is anticipated and recognized that the integrated tool carrier 84 can be properly stored and supported on a mounting/storage stand or other support structure similar to support structure 67 illustrated in FIG. 4 for quick attachment of the such integrated tool carrier to a work machine, including quick attachment in the field.

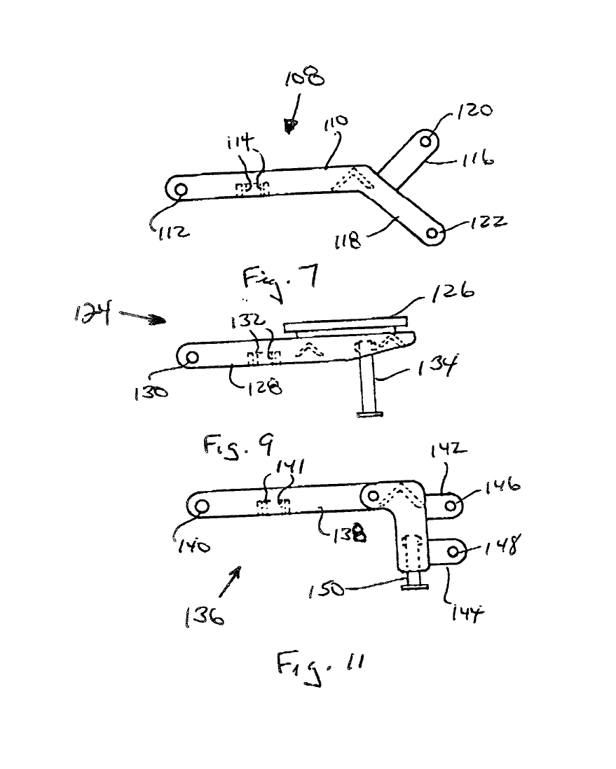

FIGS. 7 and 8 illustrate another embodiment of an adapter member 108 which is configured for use with a plurality of different types of work tools such as a dozer blade, a sanitary landfill blade, a snow plow, a scarifier, and/or a trencher. The adapter member 108 is likewise configured for easy attachment to the base module 10 and includes a pair of horizontally disposed arm portions 110 each having an opening 112 associated with one end portion thereof, the end portion of each arm 110 being insertably received and positioned between a respective pair of flanges 14 associated with base module 10 such that the openings 16 and 112 lie in registration with each other and are adaptable for receiving a pin member or some other type of suitable pivot means therethrough. Adapter member 108 likewise includes a pair of openings 114 for mating with the openings 18 associated with base module 10, suitable fastening members being positioned through the respective openings 18 and 114 for further securing the adapter member 108 to the base module 10.

The opposite end portion of adapter member 108 includes a pair of angularly oriented arm portions 116 and 118, the arm portions 116 and 118 being oriented and dimensioned for cooperatively engaging suitable attachment means associated with the particular tool to be attached thereto. In this regard, the arm portions 116 and 118 likewise include openings 120 and 122 for mating with corresponding openings associated with the particular tool to be attached thereto. Since the opposite side of the adapter member 108 is a mirror image of that illustrated in FIGS. 7 and 8, any suitable base plate or cross member structure for attaching the respective arm portions 110 may be utilized. FIG. 8 illustrates attachment of the adapter member 108 to the base module 10.

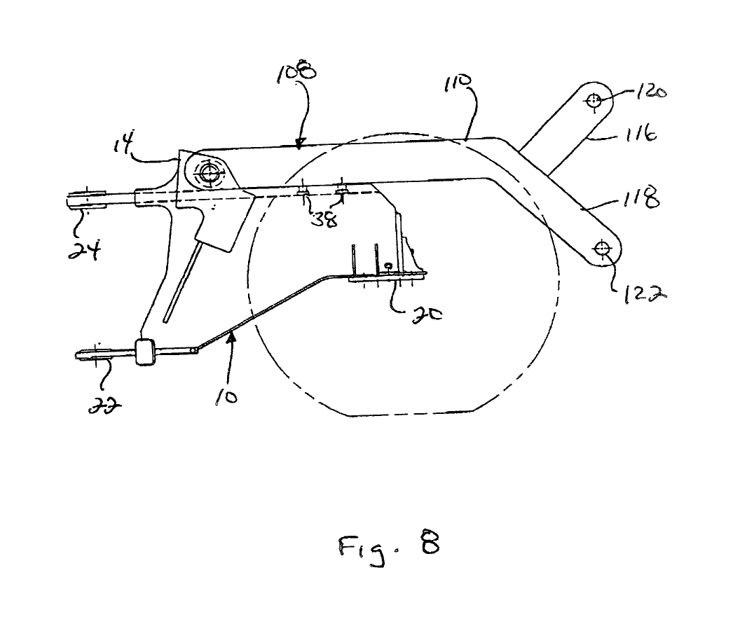

FIGS. 9 and 10 illustrate still another adapter member 124 which provides a rotating table type platform 126 for attaching to and supporting a plurality of attachment tools such as a drill, a crane boom, a telescopic boom trencher, a tree planter, or a post hole digger. Here again, adapter member 124 is configured and designed for attaching to the base module 10 and includes a pair of arm members 128 with appropriate cross structure for supporting the table platform 126, one end portion of each of the respective arm members 128 including an opening 130 for mating and registering with the openings 16 associated with base module 10. Like the arm portion 110 associated with adapter member 108, the one end portion of each arm member 128 is insertably positioned and receive between a respective pair of flanges 14 associated with base module 10 and the adapter member 124 is attached thereto through suitable attachment means which are positioned and received through the respective openings 16 and 130. Adapter member 124 likewise includes a pair of openings 132 which are positioned and located so as to mate and register with the pair of openings 18 associated with base module 10 for further securing the adapter member 124 to the base module 10 as best illustrated in FIG. 10. Adapter member 124 also includes at least one pivotally foldable support member or down rigger 134 which can be pivotally moved into a support position as best illustrated in FIG. 10 so as to provide a stable platform for the use and operation of certain types of attachment tools. Here again, adapter member 124 enables a plurality of different attachment tools to be attached for use to the same work machine capable of likewise using and controlling all of the other attachment tools previously described with respect to use of the adapter members 26, 68 and 108. Also, importantly, some of the attachment tools associated with adapter members 108 and 128 do not require use of complicated linkage arrangements.

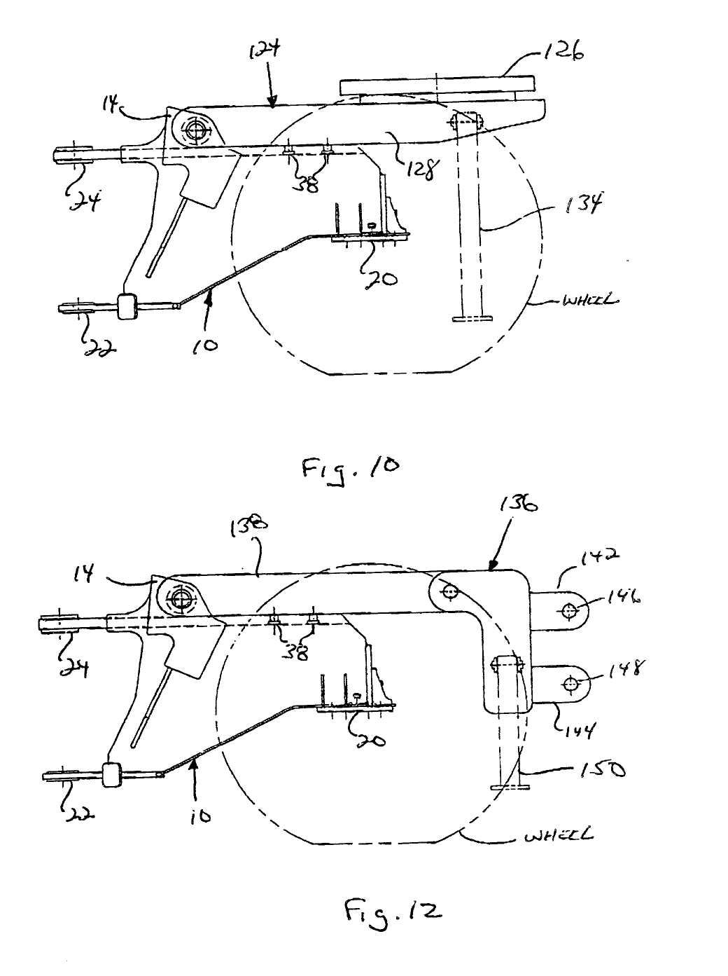

FIGS. 11 and 12 illustrate still another adapter member 136 which is likewise designed and constructed for attaching to the same base module 10 as previously explained. Adapter member 136 is a multipurpose adapter member which can be used with a plurality of different types of attachment tools such as a snow blower, a rotating brush, a vacuum cleaner, a bush/brushes cutter, a sprayer, a mast, a log stacker, and/or towing/pushing applications. Adapter member 136 likewise includes a pair of arm members 138 each having one end portion thereof adaptable for mating with a respective pair of flanges 14 associated with base module 10. In this regard, each respective arm member 138 includes an opening 140 for mating and registering with the openings 16 associated with flange portions 14. Like adapter members 108 and 124, the respective end portions of arm members 138 are positioned and located for being cooperatively received between the flanges 14 such that the openings 16 and 140 lie in registration with each other and are adaptable for receiving an attachment member or pivot means therethrough. Adapter member 136 likewise includes a pair of openings 141 which are positioned and located so as to mate and register with the pair of openings 18 associated with base module 10 for further securing adapter 136 to the base module as best illustrated in FIG. 12. Adapter member 136 also includes a respective pair of arm members 142 and 144 as best illustrated in FIGS. 11 and 12, these arms members being vertically spaced relative to each other and each including a respective opening 146 and 148 for mating with corresponding attachment means associated with the particular attachment tool to be attached thereto such as the tools identified above for use with adapter member 136. Like adapter member 124, adapter member 136 likewise includes at least one pivotally foldable support member or down rigger 150 as best shown in FIG. 12 for stabilizing member 136 during use of certain types of attachment tools.

It is recognized and anticipated that still other adapter member configurations could be utilized for coupling to both the base module 10 and at least one of a plurality of different types of attachment tools including attachment tools not specifically mentioned herein. Like the support stand 67 illustrated in FIG. 4 with respect to the bucket tool 40, suitable support stands for both the adapter members 108, 124 and 136 as well as the plurality of different attachment tools which can be coupled thereto can be utilized to store such members in the field for quick and easy attachment to the base module 10.

Industrial Applicability

As described herein, the present quick attachment system is particularly useful in small construction operations where a single work machine can be utilized to perform and accomplish a wide variety of different functions and tasks. The present system allows an operator to attach a wide variety of different types of attachment tools to a single work machine, including tools having a wide variety of different types of linkage arrangements associated therewith, thereby obviating the need for buying and/or leasing different types of work machines to accomplish different types of work applications. Instead, a single work machine equipped with the present base module 10, through the use of the plurality of adapter members disclosed herein, can be easily coupled and attached to any of the attachment tools described herein including traditional Z-bar linkage type tools, traditional integrated tool carrier type tools, a dozer blade, a sanitary landfill blade, a snow plow, a scarifier, a trencher, a drill, a crane boom, a telescopic boom trencher, a tree planter, a post hole digger, a snow blower, a rotating brush, a vacuum cleaner, a bush/brushes cutter, a sprayer, a mast, a log stacker, and towing/pushing applications.

All of the present adapter members are compatible for use with the base module 10 and use of such adapters in conjunction with the base module provide a maximum amount of flexibility and versatility regarding use of a single work machine. The present system also allows a wide variety of different types of linkage arrangements associated with various tools to be coupled to the same work machine through use of the standardized base module 10 and the plurality of adapter members described herein. As a result, the same work machine can be used in association with a greater number of different types of working tools and implements and could function as a wheel loader, a wheel dozer, a tractor, or any other type of work machine, all with the same articulated base machine and the appropriate adapter and work tool attachment. The present system also enables a quick change of such tools and implements to be accomplished in the field, if necessary.

As is evident from the foregoing description, certain aspects of the present invention are not limited to the particular details of the examples illustrated herein. It is therefore contemplated that other modifications and applications using other work attachment tools and implements, other adapter configurations, and other means for pivoting the hydraulic cylinders and linkage associated with certain types of attachment tools will occur to those skilled in the art. It is accordingly intended that all such modifications, variations and other uses and applications which do not depart from the spirit and scope of the present invention are deemed to be covered by the present invention.

Other aspects, objects and advantages of the present invention can be obtained from a study of the drawings, the disclosure and the appended claims.

1. An attachment system for coupling a plurality of work tools to a single work machine wherein the work machine includes a front frame, the system comprising:
a base module associated with the front frame of the work machine, said base module being positioned and located for attaching a work tool to the front portion of the work machine; and
a plurality of adapter members, each adapter member being cooperatively engageable with the base module and each including means for cooperatively engaging at least one of the plurality of work tools;
all of the plurality of work tools being engageable with at least one of said plurality of adapter members such that each of the plurality of work tools can be operatively coupled to the single work machine when said base module is cooperatively engaged with a work tool through engagement with one of said plurality of adapter members.

2. The attachment system, as set forth in claim 1, wherein at least one of the plurality of work tools includes associated linkage and power providers for controlling the operation thereof, at least one of said plurality of adapter members being shaped and dimensioned to operatively engage the linkage and power providers associated with the at least one work tool.

3. The attachment system, as set forth in claim 1, wherein at least one of the plurality of work tools includes a Z-bar type linkage with associated power providers, at least one of said plurality of adapter members being shaped and dimensioned to operatively engage said Z-bar type linkage and its associated power providers.

4. The attachment system, as set forth in claim 1, wherein at least one of the plurality of work tools includes an integrated tool carrier type linkage with associated power providers, at least one of said plurality of adapter members being shaped and dimensioned to operatively engage said integrated tool carrier type linkage and its associated power providers.

5. The attachment system, as set forth in claim 1, wherein one of said plurality of adapter members includes a rotating type table member.

6. The attachment system, as set forth in claim 1, wherein said cooperatively engageable means associated with at least one of said plurality of adapter members for engaging said base module includes a pair of flange members associated with each opposite side of said at least one adapter member, said flange members being positioned and located to engage a pair of corresponding flange members associated with said base module.

7. The attachment system, as set forth in claim 1, wherein said means associated with at least one of said plurality of adapter members for cooperatively engaging at least one of the plurality of work tools includes a pair of flange members associated with each opposite side of said at least one adapter member, said flange members being positioned and located for engaging corresponding members associated with the at least one of the plurality of work tools.

8. An attachment system for connecting a plurality of attachment tools to the front portion of a single work machine wherein the work machine includes an articulated front portion, and wherein at least one of the attachment tools includes a plurality of linkage members for controlling the operation of the attachment tool, the system comprising:
a base module fixed to the articulated front portion of the work machine; and
a plurality of adapter members, each adapter member being cooperatively engageable with the base module and each including means for engaging at least one of the plurality of attachment tools, at least one of said plurality of adapter members including means for mating with and engaging at least some of the plurality of linkage members associated with the at least one attachment tool;
all of the plurality of attachment tools being engageable with at least one of said plurality of adapter members such that each of the plurality of attachment tools can be operatively connected to the single work machine when said base module is cooperatively engaged with a work tool through engagement with one of said plurality of adapter members.

9. The attachment system, as set forth in claim 8, wherein the plurality of linkage members associated with the at least one attachment tool comprise a Z-bar type linkage construction with associated power providers for controlling the operation of the attachment tool, said at least one adapter member adaptable for engaging at least some of the linkage members associated with the at least one attachment tool including means for engaging said Z-bar type linkage construction and its associated power providers.

10. The attachment system, as set forth in claim 8, wherein the plurality of linkage members associated with the at least one attachment tool comprise an integrated tool carrier linkage construction with associated power providers for controlling the operation of the attachment tool, said at least one adapter member adaptable for engaging at least some of the linkage members associated with the at least one attachment tool including means for engaging said integrated tool carrier linkage construction and at least some of its associated power providers.

11. The attachment system, as set forth in claim 9, wherein said means associated with at least one of said adapter members for engaging said Z-bar type linkage construction and its associated power providers includes a pair of flange members associated with each opposite side of said adapter member and a pair of flange members located intermediate therebetween, said pair of flange members associated with each opposite side of said adapter member being positioned and located to engage at least some of the linkage members and power providers associated with said Z-bar type linkage construction, said intermediately located pair of flange members being positioned and located to engage a power provider associated with said Z-bar type linkage construction.

12. The attachment system, as set forth in claim 10, wherein said means associated with at least one of said plurality of adapter members for engaging said integrated tool carrier linkage construction and its associated power providers includes a pair of flange members associated with each opposite side of said adapter member, said flange members being positioned and located to engage at least some of the linkage members and power providers associated with said integrated tool carrier linkage construction.

13. The attachment system, as set forth in claim 8, wherein one of said plurality of adapter members includes a rotating type table member, said adapter member further including at least one pivotally movable down rigger for supporting said adapter member when attached to said base module for certain applications.

14. The attachment tool, as set forth in claim 8, wherein at least one of said adapter members includes a pair of angularly oriented arm portions positioned and located for engaging an attachment tool having a blade associated therewith.

15. The attachment system, as set forth in claim 8, wherein one of said adapter members includes a pair of vertically spaced arm members positioned and located for engaging any one of a plurality of multipurpose attachment tools, said adapter member further including at least one pivotally movable down rigger for supporting said adapter member when attached to said base module for certain applications.

16. A quick attachment system for connecting a plurality of attachment tools to the front portion of a single articulated work machine, at least one of the attachment tools having a Z-bar type linkage construction associated therewith, and at least one of the attachment tools having an integrated tool carrier type linkage construction associated therewith, the system comprising:
a base module fixed to the front portion of the articulated work machine;
a plurality of adapter members for engaging the plurality of attachment tools, each of said adapter members being cooperatively engageable with said base module and each of said adapter members further including means for engaging at least one of the plurality of attachment tools;
all of the plurality of attachment tools being engageable with at least one of said plurality of adapter members such that each of the plurality of attachment tools can be operatively connected to the single work machine when said base module is cooperatively engaged with a work tool through engagement with one of said plurality of adapter members;
at least one of said plurality of adapter members being configured to mate with an engage the Z-bar type linkage construction associated with the at least one attachment tool; and
at least one of said plurality of adapter members being configured to mate with an engage the integrated tool carrier type linkage construction associated with the at least one attachment tool.

17. The quick attachment system, as set forth in claim 16, wherein at least one of said adapter members includes a rotating type table member.

18. An attachment system for coupling a plurality of work tools to a single work machine wherein the work machine includes a front frame, the system comprising:
a base module associated with the front frame of the work machine, said base module being positioned and located for attaching a work tool to the front portion of the work machine; and
a plurality of adapter members, each adapter member configured such that the base module and at least one of the plurality of work tools may be engaged;
all of the plurality of work tools being engageable with at least one of said plurality of adapter members such that each of the plurality of work tools can be operatively coupled to the single work machine when said base module is cooperatively engaged with a work tool through engagement with one of said plurality of adapter members.

19. The attachment system, as set forth in claim 18, wherein at least one of the plurality of work tools includes a Z-bar type linkage with associated power providers, at least one of said plurality of adapter members being shaped and dimensioned to operatively engage said Z-bar type linkage and its associated power providers.

20. The attachment system, as set forth in claim 18, wherein at least one of the plurality of work tools includes an integrated tool carrier type linkage with associated power providers, at least one of said plurality of adapter members being shaped and dimensioned to operatively engage said integrated tool carrier type linkage and its associated power providers.

21. The attachment system, as set forth in claim 18, wherein said at least one of said plurality of adapter members for engaging said base module includes a pair of flange members associated with each opposite side of said at least one adapter member, and wherein said base module includes a pair of corresponding flange members, the flange members associated with said at least one adapter member being positioned and located to engage said pair of corresponding flange members associated with said base module.

22. The attachment system, as set forth in claim 18, wherein said at least one of said plurality of adapter members for engaging at least one of the plurality of work tools includes a pair of flange members associated with each opposite side of said at least one adapter member, said flange members being positioned and located for engaging corresponding members associated with the at least one of the plurality of work tools.

23. An attachment system for connecting a plurality of attachment tools to the front portion of a single work machine wherein the work machine includes an articulated front portion, and wherein at least one of the attachment tools includes a plurality of linkage members for controlling the operation of the attachment tool, the system comprising:
a base module fixed to the articulated front portion of the work machine; and
a plurality of adapter members, each adapter member being cooperatively engageable with the base module and each being cooperatively engageable with at least one of the plurality of attachment tools, at least one of said plurality of adapter members being further engageable with at least some of the plurality of linkage members associated with the at least one attachment tool;
all of the plurality of attachment tools being engageable with at least one of said plurality of adapter members such that each of the plurality of attachment tools can be operatively connected to the single work machine when said base module is cooperatively engaged with a work tool through engagement with one of said plurality of adapter members.

24. The attachment system, as set forth in claim 23, wherein the plurality of linkage members associated with the at least one attachment tool comprise a Z-bar type linkage construction with associated power providers for controlling the operation of the attachment tool, said at least one adapter member engageable with at least some of the linkage members associated with the at least one attachment tool being cooperatively engageable with said Z-bar type linkage construction and its associated power providers.

25. The attachment system, as set forth in claim 23, wherein the plurality of linkage members associated with the at least one attachment tool comprise an integrated tool carrier linkage construction with associated power providers for controlling the operation of the attachment tool, said at least one adapter member engageable with at least some of the linkage members associated with the at least one attachment tool being cooperatively engageable with said integrated tool carrier linkage construction and at least some of its associated power providers.

26. A quick attachment system for connecting a plurality of attachment tools to the front portion of a single articulated work machine, at least one of the attachment tools having a Z-bar type linkage construction associated therewith, and at least one of the attachment tools having an integrated tool carrier type linkage construction associated therewith, the system comprising:
a base module fixed to the front portion of the articulated work machine;
a plurality of adapter members for engaging the plurality of attachment tools, each of said adapter members being cooperatively engageable with said base module and each of said adapter members being further engageable with at least one of the plurality of attachment tools;
all of the plurality of attachment tools being engageable with at least one of said plurality of adapter members such that each of the plurality of attachment tools can be operatively connected to the single work machine when said base module is cooperatively engaged with a work tool through engagement with one of said plurality of adapter members;
at least one of said plurality of adapter members being configured to mate with and engage the Z-bar type linkage construction associated with the at least one attachment tool; and
at least one of said plurality of adapter members being configured to mate with an engage the integrated tool carrier type linkage construction associated with the at least one attachment tool.
